(19) United States
(12) Patent Application Publication
(10) Pub. No.: US 2025/0290614 A1
(43) Pub. Date: Sep. 18, 2025

(54) HEADLAMP FOR VEHICLES

(71) Applicant: HELLA GMBH & CO. KGAA, Lippstadt (DE)

(72) Inventors: Gerhard Kloos, Erwitte (DE); Benjamin Willeke, Paderborn (DE); Rimma Zhytnytska, Lippstadt (DE)

(21) Appl. No.: 19/069,682

(22) Filed: Mar. 4, 2025

(30) Foreign Application Priority Data
Mar. 18, 2024 (DE) 102024107635.6

(51) Int. Cl. F21S 41/63; F21S 41/255; F21S 41/43; F21S 41/663; F21W 102/155; F21Y 115/10

(52) U.S. Cl. CPC F21S 41/63; F21S 41/255; F21S 41/43; F21S 41/663; F21W 2102/155; F21Y 2115/10

(57) ABSTRACT

The invention relates to a headlamp having lenses and at least one light source. Each lens includes a flat light entry surface and a curved light exit surface. Multiple lenses are integrally connected to one another to produce a predetermined light distribution. The lenses include: a front field light lens designed such that light emitted by the light source is radiated by the front field light lens to form a partial light distribution in a front field area of a low beam distribution; a range lens designed such that light emitted by the light source is reproduced by the range lens to form a partial light distribution in range area of a low beam distribution; and a high beam lens designed such that light emitted by the light source is reproduced to form a partial light distribution in a long-distance area above a cut-off line of the low beam distribution.

### CROSS-REFERENCE TO RELATED APPLICATIONS

The present application claims the benefit of German Patent Application No. 10-2024-107-635.6, filed Mar. 18, 2024, the disclosure of which is incorporated by reference.

### BACKGROUND OF THE INVENTION

The invention relates to a headlamp for vehicles having a number of light sources and having a number of lenses arranged in front of the at least one light source in the main radiation direction, each having a flat light entry surface arranged on a side facing the light source and having a curved light exit surface arranged on a side facing away from the at least one light source, wherein a plurality of lenses is connected integrally to one another to produce a predetermined light distribution.

DE 10-2018-131-027 A1 discloses a headlamp for vehicles that has a light module consisting of three lenses to produce a low beam distribution. Each lens is associated with a light source. A diaphragm element having a diaphragm edge contour is arranged between the light source and a flat light entry surface of the respective lenses, such that the diaphragm edge contour is reproduced by the lens to produce a cut-off line of the low beam distribution. The three lenses are arranged next to one another in a horizontal direction, wherein a middle lens produces a different partial light distribution than the outer lenses arranged opposite one another. As the marginal edges of the curved light exit surface are arranged at a distance from the light entry surface, the outgoing luminous flux is limited.

### SUMMARY OF THE INVENTION

The object of the present invention is to further develop a headlamp for vehicles such that the effectiveness is increased in a simple manner, wherein, in particular, a high beam distribution can also be produced.

To achieve this object, a headlamp is provided. The headlamp includes: a number of front field light lenses, the front field light lens being designed such that a light emitted by the at least one light source is radiated by means of the front field light lens to form a partial light distribution in a front field area of a low beam distribution; a number of range lenses, wherein the range lens is designed such that a light emitted by the at least one light source is reproduced by means of the range lens to form a partial light distribution in a range area of a low beam distribution; and a number of high beam lenses, wherein the high beam lens is designed such that a light emitted by the at least one light source is reproduced to form a partial light distribution in a long-distance area above a cut-off line of the low beam distribution.

The particular advantage of the invention is that by splitting the function of lenses for producing a range light distribution, a front field light distribution and a high beam light distribution, a low beam light distribution and a high beam light distribution can be generated in a simple manner. By splitting the lens function to produce partial light distributions for a range light and a front field light, a high-intensity low beam distribution can be produced in a targeted manner.

According to a further development of the invention, a light source is arranged directly adjacent to or at a small distance from a light entry side of the front field light lens and/or the range light lens, such that in cooperation with the same lenses an edge of the light source is reproduced to form a cut-off line of the low beam distribution. This has the advantage of reducing manufacturing effort, since no diaphragm or shutter is required. The partial light distributions or the resulting light distribution is achieved solely by a combination of a light source and a lens, wherein a plurality of lenses is provided to produce the low beam distribution.

According to a further development of the invention, a flat beam diaphragm element having such a plurality of recesses is provided between the light source and the light entry surface of the range light lens and/or the front field light lens such that light rays are suppressed or absorbed in an outer edge area of the light impinging on the light entry surface of the lens or are prevented from entering the lens. This beam diaphragm element is only hit by a few marginal beams, such that there is no diaphragm function.

According to a further development of the invention, a first light module is provided which has two front field light lenses. A first front filed light lens is designed such that a first partial light distribution is reproduced in a front field area of a low beam light distribution, wherein a light focus of the first partial light distribution is located in a portion of the front field area of the low beam light distribution, by means of which an oncoming lane is illuminated.

Furthermore, the first light module has a second front field light lens, which is used to produce a second partial light distribution, wherein the second partial light distribution has a greater scattering width than the first partial light distribution of the first front field light lens. The second partial light distribution extends along a narrow band directly below a cut-off line extending along the zero line.

According to a further development of the invention, the first front field light lens is arranged pivoted by an acute angle in relation to a vertical axis, such that the light focus of the first partial light distribution is localized in the area of the oncoming lane.

According to a further development of the invention, the second front field light lens is designed such that a maximum horizontal right-hand scattering angle in relation to an optical axis is greater than a maximum left-hand scattering angle in the horizontal direction or vice versa. The second front field light lens can, for example, be arranged mirror-inverted in a right and left headlamp in relation to a vertical axis, such that the second partial light distribution of a right headlamp and a left headlamp are superimposed to form a symmetrical resulting partial light distribution. Advantageously, the second front field light lens only needs to be designed such that it has a relatively large scattering angle on a first side, while the maximum scattering angle is smaller on the opposite side.

According to a further development of the invention, a high beam lens is arranged between the first front field light lens and the second front field light lens, wherein these lenses are integrally connected to one another. Advantageously, this forms a compact first light module that can produce a high beam distribution in addition to a partial low beam distribution.

According to a further development of the invention, a second light module is provided that has two range light lenses. A first range lens is designed such that a first partial light distribution is reproduced into the range area of the low beam distribution, wherein an area directly below the cut-off line is illuminated.

Optionally, a second range light lens is designed such that a second partial light distribution is reproduced in the range area of the low beam light distribution, which has a greater distance to the cut-off line than the first partial light distribution of the first range light lens. By combining these two range light lenses, optimized lighting can be achieved in the range area.

According to a further development of the invention, the second range light lens is designed such that the second partial light distribution produced in this way fulfills a statutory 75R light value of the low beam distribution in the range area. For example, the first range light lens and the second range light lens can be rotationally symmetrical to an optical axis.

According to a further development of the invention, a high beam lens is arranged between the first range light lens and the second range light lens, such that the high beam function can also be realized.

According to a further development of the invention, a marginal edge of the range light lens and/or the front field light lens and/or the high beam lens extends in the vicinity of or directly at a light entry surface of the respective lenses. The light exit surface of these lenses therefore extends in a solid angle range of 180° in relation to the optical axis, such that effective light emission is guaranteed.

### BRIEF DESCRIPTION OF THE DRAWINGS

Exemplary embodiments of the invention are explained in more detail below with reference to the drawings. In the Figures:

FIG. 1 is a schematic top view of a headlamp having a first light module (left) and a second light module (right);

FIG. 2 is a representation of two overlapping partial light distributions of the first light module to produce a low beam distribution;

FIG. 3 is a superposition of two overlapping partial light distributions of the second light module to produce the low beam distribution;

FIG. 4 is a resulting light distribution when all light sources of the two light modules are activated; and

FIG. 5 is a front view of the first light module.

### DETAILED DESCRIPTION OF THE CURRENT EMBODIMENT

A headlamp for vehicles is used to produce a predefined low beam distribution, which for example produces a low beam distribution 1 and a high beam distribution 2.

The headlamp has a plurality of lenses, each with the same associated light sources, which are used to produce a partial light distribution. By superimposing these partial light distributions, the low beam distribution 1 is produced and, with the further addition of lenses reproducing over a cut-off line (HDG), the high beam distribution 2 is produced.

In the present exemplary embodiment, it is assumed that the headlamp has a first light module 3 and a second light module 4. What the two light modules 3 and 4 have in common is that they each have three lenses that are integrally connected to one another. Each lens is associated with at least one light source.

FIG. 1 shows an example of a left headlamp of a vehicle. The first light module 3 comprises a first front field light lens 5 for producing a first partial light distribution 8 in a front field area VB, a second front field light lens 6 for producing a second partial light distribution 9 in the front field area VB, and a high beam lens 7 for producing a first partial light distribution 10 in a long-distance area FB of a space in front of the vehicle.

The second light module 4 has a first range light lens 11 for producing a first partial light distribution 14 in a range area RB, a second range light lens 12 for producing a second partial light distribution 15 in the range area RB, and a second high beam lens 13 for producing a second partial light distribution 16 in the long-distance area FB of the space in front of the vehicle.

The lenses 5, 6, 7, 11, 12, 13 are designed as anamorphic lenses whose shape has been optimized for the partial light distributions to be produced. The lenses 5, 6, 7, 11, 12, 13 each have a flat light entry surface 17 and a curved light exit surface 18. These identical component functions are provided with the same reference signs.

It can be seen that a marginal edge 19 of the light exit surfaces 18 of the lenses 5, 6, 7, 11, 12, 13 extends to a connecting area 20, which extends in the vicinity of or directly to the light entry surface 17, which has the light entry surface 17 on a side opposite the lenses. In particular, in the second light module 4, the light exit surface 18 of the lenses 11, 12, 13 extends at a solid angle of 180° relative to an optical axis 26. In contrast, the marginal edges 19 of the lenses 5, 6, 7 of the first light module 3 only extend into a solid angle range of 160° relative to the optical axis 26. Marginal edges 19 of adjacent lenses 5, 6, 7 therefore adjoin the marginal edges 19 of the adjacent lens 5, 6, 7 on a side facing the lens sides.

While the light entry surfaces 17 of the second light module 4 extend planar to one another, the light entry surfaces 18 of the first light module 3 do not extend in one plane. The lens 5 is arranged in a secondary portion 23 rotated by a twist angle φ relative to the other lenses 6, 7 of a main portion 22 about a vertical axis. The first front field light lens 5 is arranged in a manner pivoted relative to the second front field light lens 6 and the first high beam lens 7 by the twist angle φ extending in a horizontal plane. This twisted arrangement of the first front field light lens 5 causes the light coupled into it to be directed towards an oncoming lane. The resulting first partial light distribution 8 has the shape of a half-filled ellipse. The first front field light lens 5 has the shape of a solid ellipsoid and corresponds to an anamorphic lens. The twist angle φ can be 10°, for example.

Each lens 5, 6, 7, 11, 12, 13 is associated with a light source 24, which is preferably positioned directly at the light entry surface 17. The light source 24 is arranged with its main axis perpendicular to the light entry surface 17. The light sources 24 are each located on an optical axis 26 of the respective lenses 5, 6, 7 or 11, 12, 13.

By aligning the first front field light lens 5 in the direction of the oncoming lane, a focus S of the first partial light distribution 8 is located on the oncoming lane. As can be seen in FIG. 2, the first partial light distribution 8 directly adjoins a part of the cut-off line (HDG) that extends along the zero line.

The second front field light lens 6 is shaped such that the second partial light distribution 9 produced in this way also adjoins to the part of the cut-off line (HDG) that extends through the horizontal zero line. In contrast to the first partial light distribution 8, however, the second partial light distribution 9 has a greater scattering width. The second partial light distribution 9 extends as a narrow band below the zero line of the cut-off line (HDG) and thus serves to illuminate a smaller vertical area of the low beam light distribution 1 than the first partial light distribution 5.

FIG. 1 shows a left headlamp of the vehicle. A right headlamp of the vehicle, which is not shown, has the same design with the following exception. The second front field light lens 6 is arranged mirror-inverted to the second front field light lens 6 of the left headlamp with respect to a vertical center plane, such that the second partial light distribution 9 of the right headlamp is also mirror-inverted to the second partial light distribution 9 of the left headlamp. While the second partial light distribution 9 of the left headlamp has a relatively large portion in the negative area of the horizontal H and a smaller portion in the positive horizontal area, the second partial light distribution 9 of the right headlamp has a relatively large portion in the positive area of the horizontal H and a small portion in the negative area of the horizontal H. When the right and left headlamps are activated, the asymmetrical second partial light distributions 9 are thus superimposed to form a resulting partial light distribution that is symmetrical in relation to a vertical V and extends with a relatively narrow band below the horizontal zero line H or adjacent to the horizontal zero line H.

The first high beam lens 7 is arranged between the first front field light lens 5 and the second front field light lens 6. The lenses 5, 6, 7 are integrally connected to one another. The first high beam lens 7 can be rotationally symmetrical and produces the first partial light distribution 10, which extends above the cut-off line (HDG).

Like the first light module 3, the second light module 4 has the central second high beam lens 13, which can, for example, be the same as the first high beam lens 7 of the first light module 3. For example, it can be designed to be rotationally symmetrical.

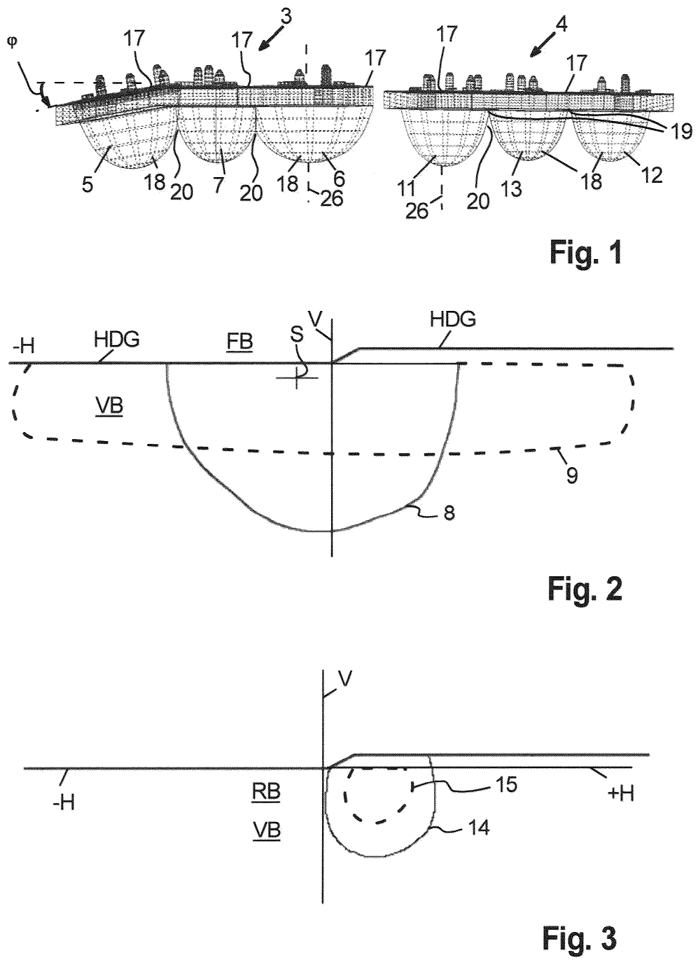

The first range lens 11 of the second light module 4 is designed such that it mainly illuminates its own lane. As can be seen from FIG. 3, the first partial light distribution 14 of the first range light lens 11 extends in a positive horizontal range H below the cut-off line (HDG) and preferably above the horizontal line H.

The second range lens 12 is designed such that the second partial light distribution 15 is used to achieve a legally required 75R light value in the central area of the low beam light distribution 1.

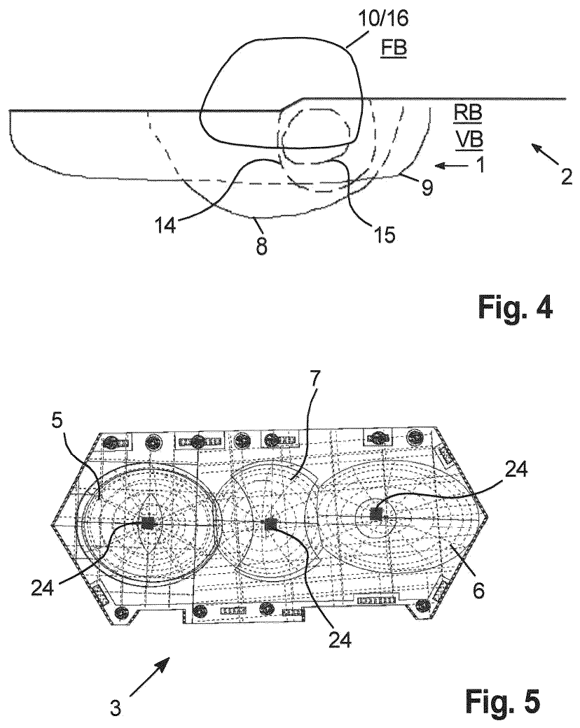

FIG. 4 shows the superimposition of all produced partial light distributions. The first partial light distributions 8, 14 and 9, 15 caused by the first and second front field light lenses 5, 6 and first and second range light lenses 11, 12 are used to produce the low beam light distribution 1. If the high beam distribution 2 is to be produced, the light sources associated with the first high beam lens 7 and the second high beam lens 13 are also switched on such that the first partial light distribution 10 of the first light module 3 and the second partial light distribution 16 of the second light module 4 are produced above the cut-off line (HDG).

The light sources 24 associated with the first front field light lens 5 and the second front field light lens 6 or the first range light lens 11 and the second range light lens 12 are arranged in the area of the optical axis 26 such that an edge of the respective light sources 24 is reproduced to form the cut-off line (HDG) of the low beam distribution 1. An additional diaphragm having a diaphragm edge that is reproduced to form a cut-off line (HDG) is not provided.

According to an alternative embodiment of the invention not shown, only a single high beam lens can be provided if the associated light source is relatively bright.

According to an alternative embodiment of the invention not shown, the first light module 3 and the second light module 4 can be integrally connected to one another.

The first light module 3 and the second light module 4 are each manufactured by injection molding. They are made of a plastic material.

The light sources 24 are preferably designed as LED light sources, which are preferably positioned on a common printed circuit board.

According to an alternative embodiment of the invention, between the respective light sources 24 and the light entry surface 17 and/or the range light lens 11, 12 and/or high beam lens 7, 13, a flat beam diaphragm element not shown can be provided having such a plurality of recesses that the light beam emitted by the light source 24 is suppressed in an outer edge area thereof. This prevents scattered light from entering the respective lenses.

Preferably, the light sources 24 are arranged directly on the first front field light lens 5, 6 and/or first range light lens 11, 12 and/or first high beam lens 7, 13.

According to the present exemplary embodiment, each lens 5, 6, 7; 11, 12, 13 is associated with a single LED light source.

### LIST OF REFERENCE NUMERALS

1 low beam distribution
2 high beam distribution
3 first light module
4 second light module
5 first front field light lens
6 second front field light lens
7 first high beam lens
8 first partial light distribution
9 second partial light distribution
10 first partial light distribution
11 first range light lens
12 second range light lens
13 second high beam lens
14 first partial light distribution
15 second partial light distribution
16 second partial light distribution
17 light entry surface
18 light exit surface
19 marginal edge
20 connecting area
22 main portion
23 secondary portion
24 light source
25 back
26 optical axis
H horizontal
S focus
V vertical plane
HDG cut-off line
VB front field area
FB long-distance area
RB range area
φ swivel angle/twist angle

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlamp for vehicles, the headlamp comprising:
a plurality of light sources; and
a plurality of lenses arranged in front of the plurality of light sources in a main radiation direction, each of the plurality of lenses having a flat light entry surface on a side facing the plurality of light sources and having a curved light exit surface on a side facing away from the plurality of light sources, wherein at least two of the plurality of lenses are connected integrally to each other to produce a predetermined light distribution, wherein the plurality of lenses comprise:
a plurality of front field light lenses to provide a partial light distribution in a front field area of a low beam distribution,
a plurality of range light lenses to provide a partial light distribution in a range area of the low beam distribution, and
a plurality of high beam lenses to provide a partial light distribution in a long-distance area above a cut-off line of the low beam distribution.

2. The headlamp of claim 1, wherein corresponding ones of the plurality of light sources are arranged directly adjacent to the flat light entry side of the plurality of front field light lenses, the plurality of range light lenses, and the plurality of high beam lenses.

3. The headlamp of claim 1, wherein the plurality of range light lenses or the plurality of front field light lenses are configured such that an edge of the plurality of light sources is reproduced to form a cut-off line of the low beam distribution.

4. The headlamp of claim 1, wherein a flat beam diaphragm element having a plurality of recesses is provided on the flat light entry surface of the plurality of front field lenses or the plurality of the range light lens for suppressing light beams in an outer edge area of a light beam radiated by the plurality of light sources.

5. The headlamp of claim 1, wherein:
a first light module is provided having the plurality of front field light lenses and a corresponding number of the plurality of light sources,
the plurality of front field light lenses being configured such that a first partial light distribution is reproduced in the front field area of the low beam distribution, and
a focus of the first partial light distribution is arranged in a portion of the front field area, such that an oncoming lane is illuminated.

6. The headlamp of claim 1, wherein:
a first one of the plurality of front field light lenses is angled relative to a second one of the plurality of front field light lenses;
the first one of the plurality of front field light lenses produces a first partial light distribution;
the second one of the plurality of front field light lenses produces a second partial light distribution; and
the second partial light distribution has a greater horizontal scattering width than the first partial light distribution.

7. The headlamp of claim 6, wherein:
the second one of the plurality of front field light lenses is configured such that a maximum horizontal right-hand scattering angle extending with respect to an optical axis is greater than a maximum horizontal left-hand scattering angle or vice versa; and
the second one of the plurality of front field light lenses of a right headlamp and of a left headlamp of the vehicle are arranged complimentary to each other with respect to the optical axis, such that by superimposing the second partial light distribution of the left headlamp and of the right headlamp, a resulting second partial light distribution of the second front field light lens extends symmetrically with respect to a vertical plane extending through the optical axis.

8. The headlamp of claim 6, wherein the flat light entry surface of the first one of the plurality of front field light lenses is arranged at an acute angle relative to a vertical plane with respect to the flat light entry surface of the second one of the plurality of front field light lenses.

9. The headlamp of claim 6, wherein one of the plurality of high beam lenses is arranged between the first one of the plurality of front field light lenses and the second one of the plurality of front field light lenses, each being integrally connected to each other.

10. The headlamp of claim 5, wherein:
a second light module is provided having the plurality of range light lenses and a corresponding number of the plurality of light sources,
a first one of the plurality of range light lenses being configured such that a first partial light distribution thereof is reproduced in the range area of the low beam distribution, wherein an area directly below the cut-off line is illuminated.

11. The headlamp of claim 1, wherein:
the plurality of range light lenses includes a first range light lens and a second range light lens;
the first range light lens generates a first partial light distribution and the second range light lens generates a second partial light distribution; and
the second partial light distribution has a greater distance to a horizontal zero line than does the first partial light distribution.

12. The headlamp of claim 11, wherein the second range light lens is configured such that a 75R light value of the low beam distribution is generated by the partial light distribution of the second range light lens.

13. The headlamp of claim 11, wherein the plurality of high beam lenses includes a high beam lens disposed between the first range light lens and the second range light lens, each being integrally connected to each other.

14. The headlamp of claim 13, wherein the flat light entry surface of each of the high beam lens, the first range light lens, and the second range light lens extend in a common plane.

15. The headlamp of claim 1, wherein a marginal edge of one of the plurality of lenses extends to a light entry surface thereof.
